(19) United States
(12) Patent Application Publication
(10) Pub. No.: US 2019/0320145 A1
(43) Pub. Date: Oct. 17, 2019

(54) ASSEMBLY AND METHOD FOR INSPECTING COMPONENTS

(71) Applicant: ISMECA SEMICONDUCTOR HOLDING SA, La Chaux-de-Fonds (CH)

(72) Inventors: Jerome PARATTE, Tramelan (CH); Pierrick ABRIAL, Neuchâtel (CH); Thierry EME, Villers-le-Lac (FR)

(73) Assignee: ISMECA SEMICONDUCTOR HOLDING SA, La Chaux-de-Fonds (CH)

(21) Appl. No.: 16/474,945

(22) PCT Filed: Feb. 2, 2017
(86) PCT No.: PCT/IB2017/050563

§ 371 Date: Jun. 28, 2019

(51) Int. Cl. H04N 7/18; G01N 21/88; G06T 7/00; H04N 5/225; H04N 5/232

(52) U.S. Cl. CPC H04N 7/183; G01N 21/8851; G06T 7/0002; G06T 2207/30108; H04N 5/23222; G01N 2201/025; H04N 5/2253

(57) ABSTRACT

According to the present invention there is provided a method of inspecting a component (10), using an assembly comprising a camera (3) with a fixed position, and a moveable stage (5), wherein the moveable stage is configured such that it can rotate about a rotation axis (7), and, can move linearly along two linear axes (9a, 9b) wherein said two linear axes are perpendicular to one another and wherein both of said two linear axes are each perpendicular to the rotation axis, the method comprising the steps of, (a) providing a first component into a predefined orientation on the stage, such that a first side of the component is facing a camera; (b) moving the stage linearly along one or more of said two linear axes so as to bring the first side of the first component into focus of the camera; (c) capturing an image of the first side of the first component after it has been brought into focus of the camera. An assembly according to the above comprising additionally a processor which is configured to determine whether the image of the component is in-focus of the camera, and if not, to determine a movement of the moveable stage and to initiate the moveable stage to undergo said determined movement so as to bring the component into focus is also provided.

### FIELD OF THE INVENTION

The present invention concerns an assembly and method for inspecting components, and in particular an assembly and method for inspecting components for micro-cracks and other contaminants, in which a moveable stage is moved to predetermined position(s) to bring different sides of the component in to focus of a camera.

### DESCRIPTION OF RELATED ART

In existing assemblies and methods for inspecting components, a component is placed into a predefined position to be within the view of a camera; the camera is then focused on the component and an image is captured of the component. The image is then inspected to identify if there are any cracks or contaminants in the component. When inspecting a plurality components, these afore-mentioned steps are repeated for each of the plurality of components; so for each component the camera is focused to bring the component into focus of the camera. Disadvantageously this makes existing assemblies and methods for inspecting components slow.

It is an object of the present invention to obviate or mitigate at least some of the above-mentioned disadvantages.

### BRIEF SUMMARY OF THE INVENTION

According to the invention there is provided a method of inspecting a component, using an assembly comprising a camera with a fixed position, and a moveable stage, wherein the moveable stage is configured such that it can rotate about a rotation axis, and, can move linearly along two linear axes wherein said two linear axes are perpendicular to one another and wherein both of said two linear axes are each perpendicular to the rotation axis, the method comprising the steps of, providing a first component into a predefined orientation on the stage, such that a first side of the component is facing a camera; moving the stage linearly along one or more of said two linear axes so as to bring the first side of the first component into focus of the camera; capturing an image of the first side of the first component after it has been brought into focus of the camera.

The method may comprise the steps of, while maintaining the stage in the same position along the linear axes as when the image of the first side was captured, rotating the stage about said rotation axis so that a second side of the first component is facing the camera; capturing an image of the second side of the first component after it has been brought into focus of the camera.

The method may comprise the steps of, while maintaining the stage in the same position along the linear axes as when the image of the first side was captured, removing the first component from the stage; providing a second component, which has the same dimensions as the first component, into a predefined orientation on the stage, such that a first side of the second component is facing a camera; capturing an image of the first side of the second component using the camera; rotating the stage about said rotation axis so that a second side of the second component is facing the camera; capturing an image of the second side of the second component using the camera.

In an embodiment said first component is a cube-shaped component.

The method may comprise the steps of, storing, in a memory, first position data indicative of the position of the stage along said two linear axes, when the first side of the first component is in focus of the camera; rotating the stage about said rotation axis so that a second side of the first component is facing the camera; moving the stage linearly along one or more of said two linear axes so as to bring the second side of the first component into focus of the camera; storing, in a memory, second position data indicative of the position of the stage along said two linear axes, when the second side of the first component is in focus of the camera; capturing an image of the second side of the first component after it has been brought into focus of the camera.

The method may comprise the steps of,

rotating the stage about said rotation axis so that a third side of the first component is facing the camera;

retrieving the first position data from the memory, and moving the stage to a position corresponding to the position indicated in the retrieved first position data, so as to bring the third side of the first component into focus;

capturing an image of the third side of the first component after it has been brought into focus of the camera;

rotating the stage about said rotation axis so that a fourth side of the first component is facing the camera;

retrieving the second position data from the memory, and moving the stage to a position corresponding to the position indicated in the retrieved second position data, so as to bring the fourth side of the first component into focus of the camera;

capturing an image of the fourth side of the first component after it has been brought into focus of the camera.

The method may comprise the steps of,

removing the first component from the stage; providing a second component, which has the same dimensions as the first component, into a predefined orientation on the stage, such that a first side of the second component is facing a camera;

capturing an image of the first side of the second component using the camera;

rotating the stage about said rotation axis so that a second side of the second component is facing the camera;

retrieving the second position data from the memory, and moving the stage to a position corresponding to the position indicated in the retrieved second position data, so as to bring the second side of the second component into focus of the camera;

capturing an image of the second side of the second component using the camera.

The method may further comprise the steps of, retrieving the first position data from the memory, and moving the stage to a position corresponding to the position indicated in the retrieved first position data, so as to bring the first side of the second component into focus of the camera.

In an embodiment said first component is a rectangular-cuboid-shaped component.

The method may further comprise the steps of, inspecting a captured image to identify if the side of the component has a crack or is contaminated.

The method may comprise the steps of,

removing the first component from the stage,

providing a second component which has dimensions which are different to the dimensions of the first component, into said predefined orientation on the stage such that a first side of the second component is facing a camera;

retrieving first position data from memory, and moving the stage to a position corresponding to the position indicated in the retrieved first position data;

capturing an image of the first side of the second component using the camera;

detecting from the captured image that the second component is out of the focus of the camera;

moving the stage linearly along one or more of said two linear axes so as to bring the first side of the second component into focus of the camera;

capturing an image of the first side of the second component after it has been brought into focus of the camera;

storing, in a memory, third position data indicative of the position of the stage along said two linear axes, when the first side of the second component is in focus of the camera;

rotating the stage about said rotation axis so that a second side of the second component is facing the camera;

moving the stage linearly along one or more of said two linear axes so as to bring the second side of the second component into focus of the camera;

storing, in a memory, fourth position data indicative of the position of the stage along said two linear axes, when the second side of the second component is in focus of the camera;

capturing an image of the second side of the second component after it has been brought into focus of the camera.

In an embodiment the step of moving the stage linearly along one or more of said two axis so as to bring the first side of the first component into focus of the camera comprises moving the stage in a direction towards, and/or away from the camera. In an embodiment the step of moving the stage linearly along one or more of said two axis so as to bring the second side of the first component into focus of the camera comprises moving the stage in a direction towards, and/or away from the camera.

In an embodiment the step of moving the stage linearly along one or more of said two axis so as to bring the first side of the first component into focus of the camera comprises moving the stage to bring the first side to a position of a focal point of a lens of the camera. In an embodiment the step of moving the stage linearly along one or more of said two axis so as to bring the second side of the first component into focus of the camera comprises moving the stage to bring the second side to a position of a focal point of a lens of the camera.

According to a further aspect of the present invention there is provided an assembly for inspecting a component, the assembly comprising,

a camera having a fixed position; and

a moveable stage, wherein the moveable stage is configured such that it can rotate about a rotation axis, and, can move linearly along two linear axes wherein said two linear axes are perpendicular to one another and wherein both of said two linear axes are each perpendicular to the rotation axis;

a processor which is configured to, receive an image captured by the camera and to determined if the image is in-focus and, if the image is not in-focus then determines a movement of the moveable stage required to bring the component into focus of the camera, and to initiate the moveable stage to undergo said determined movement so as to bring the component into focus of the camera.

### BRIEF DESCRIPTION OF THE DRAWINGS

The invention will be better understood with the aid of the description of an embodiment given by way of example and illustrated by the figures, in which:

FIG. 1 shows a perspective view of an assembly according to an aspect of the present invention, which can be used to implement various methods of the present invention of inspecting components ;

FIG. 2a shows the assembly in use to inspect a cube-shaped component using a method according to an embodiment of the present invention;

FIG. 2b shows the assembly in use to inspect a cube-shaped component, which has the same dimensions as the cube-shaped component shown in FIG. 2a, using a method according to an embodiment of the present invention;

FIG. 3a shows a perspective view of the assembly in use to inspect a rectangular-cuboid-shaped component, using a method according to a further embodiment of the present invention;

FIG. 3b shows a perspective view of the assembly in use to inspect a rectangular-cuboid-shaped component, which has the same dimensions as the rectangular-cuboid-shaped shown in FIG. 3a, using a method according to a further embodiment of the present invention;

FIG. 4 shows a perspective view of the assembly in use to inspect a rectangular-cuboid-shaped component, which has different dimensions to the rectangular-cuboid-shaped component shown in FIGS. 3a and 3b, using a method according to a further embodiment of the present invention.

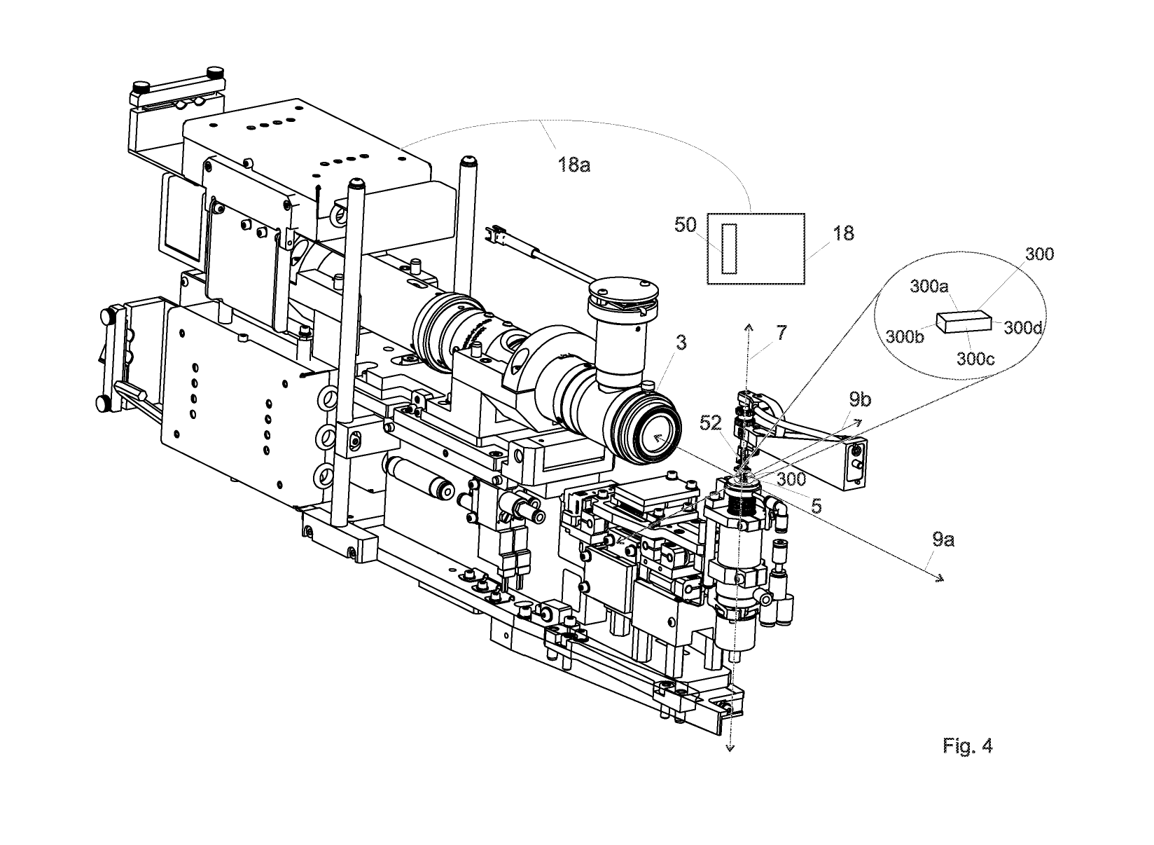

### DETAILED DESCRIPTION OF POSSIBLE EMBODIMENTS OF THE INVENTION

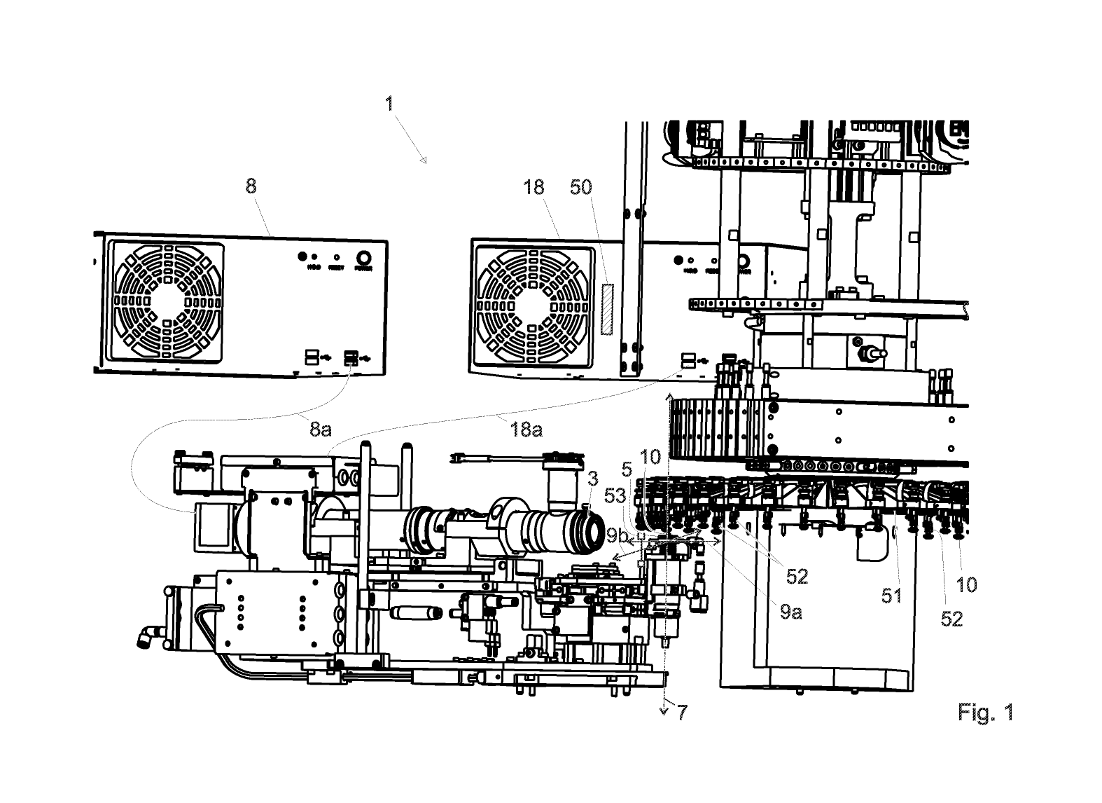

FIG. 1 provides a perspective view of an assembly 1 according to an aspect of the present invention, for inspecting components 10.

The assembly 1 comprises a camera 3 having a fixed position. The camera 3 may take any suitable form. Preferably the camera 3 will be a high resolution camera which can capture an image having a resolution of 4 mega-pixels, 8 mega-pixels, 9 mega-pixels, 12 mega-pixels, or 29 mega-pixels. In the preferred embodiment the camera 3 will be a high resolution camera which can capture an image having a resolution between 5-12 mega-pixels.

Preferably the camera 3 will have a lens which has a 12.5:1 zoom.

The camera 3 will have a light source which can be used to illuminate the object which is being photographed. Preferably the light source is configured to emit white light. However in another embodiment the camera 3 will be configured such that a user can chose the type of light which is used to illuminate the object which is being photographed; for example the camera 3 may comprise a filter which may be selectively used to block predefined wavelengths of light so that the object is illuminated only with the wavelengths which pass through the filter; in another embodiment the camera may comprise a plurality of different light sources which can emit different wavelengths of light, which may be selectively operated, for example the camera 3 may comprise a plurality of monochrome light sources (e.g. a blue light source which can emit blue light, a green light source which can emit green light, and a red light source which can emit red light), the monochrome light sources can be selectively operated to emit light so that the object can be illuminated with blue, green, or red light or any combination of blue, green, or red light. In another example the camera 3 may comprise an infrared light source which may be selectively operated to illuminate the object which is to be photographed using infrared light. Thus it will be understood that the camera 3 may have any possible configuration of light sources which enable changing the colour of the light which is used illuminate the object which is be photographed; however in the preferred embodiment the camera 3 comprises a light source which emits white light.

The assembly 1 further comprises a moveable stage 5. The moveable stage 5 is configured such that it can rotate about a rotation axis 7, and, can move linearly along two linear axes 9a, 9b (x and y axes respectively; the rotation axis 7 is a z-axis). The rotation axis 7 passed through a centre of the stage 5; in other words the stage 5 can rotate about its centre. Said two linear axes 9a,9b are perpendicular to one another, and both of said two linear axes 9a,9b are each perpendicular to the rotation axis 7. The stage 5 can be moved along a first linear axis 9a so as to be moved towards or away from the camera 3; the stage 5 can be moved along a second linear axis 9b so as to be moved left or right with respect to the camera 3. It should be understood that the moveable stage 5 may take any suitable configuration, in the preferred embodiment the moveable stage 5 comprises a moveable platform having a surface on which a component can be supported, however in another embodiment the moveable stage 5 may have the form of a gripper which can grip and hold a component.

The assembly 1 further comprises a processor 8 which is configured to, receive via a communication link 8a, an image of a component on the stage 5 which has been captured by the camera 3 and to determined if the image is in-focus. Specifically the processor 8 carries out image processing on the image an provides a value which is indicative of level of focus of the image. For example an image of a component on the stage 5 captured by the camera 3 which is not in focus may be awarded only 50-60% level of focus; but an image of a component on the stage 5 captured by the camera 3 which is in focus may be awarded only 90-100% level of focus. The level of focus can be adjusted by moving the stage 5 (which supports the component whose image is captured) relative to the camera 3 i.e. by moving the stage 5 linearly along one or more of said two linear axes 9a, 9b, and/or rotating the stage 5 about the rotation axis 7. For example, when the stage 5 is too close to the camera 3 then the level of focus of the image will be poor and so the processor will award the captured image a low level of focus; likewise when the stage 5 is too far from the camera 3 then the level of focus of the image will also be poor and so the processor will award the captured image a low level of focus; thus the stage 5 is moved until the optimum position is achieved whereby the image captured by the camera 3 will show the component in focus.

Typically the user will set an threshold focus level e.g. 80% level of focus, and when the level of focus of an image of a component on the stage 5 captured by the camera is below this threshold focus level then the stage is moved iteratively to new positions and a new image is captured at each position, until the stage has reached a position where the captured image of a component on the stage 5 has a level of focus which is above the threshold focus level, as will be discussed in more details below.

In this embodiment a second processor 18, is provided which can be used to set the position of the stage 5. The second processor 18 is connected, via a communication link 18a, to actuators which are operable to move the stage 5 along the linear axes 9a, 9b and/or rotation axis 7; a user may provide the second processor 18 with position coordinates (e.g. by entering position coordinates using a keyboard) and the second processor 18 then operates the actuators to move the stage 5 to a position corresponding to the entered position coordinates. It should be understood that in another embodiment only a single processor is provided; the single processor being configured to carry out the same functions as the processor 8 and second processor 18 combined. In one embodiment the movement of the stage is done manually by a user, and, in another embodiment the movement of the stage is automated. For example in one embodiment a user reads the value indicative of level of focus of the image which has been provided by the processor; if the value is below the threshold focus level then the user will manually move the stage iteratively to new positions (i.e. moving the stage iteratively along one or both of the linear axes 9a, 9b and/or iteratively rotating the stage 5 about the rotation axis 7) until the stage has reached a position where the captured image of a component on the stage 5 has a level of focus which is above the threshold focus level.

In another embodiment the movement of the stage is automated. For example the assembly 1 may further comprise actuators which can selectively move the stage 5 to rotate about a rotation axis 7, and/or move linearly along one or both of the linear axes 9a, 9b. The second processor 18,is configured to initiate operation of these actuators based on the image processing; for example if the second processor 18 determines that the level of focus of a captured image of a component on the stage 5 is below the threshold focus level, then the processor will initiate the actuators to automatically move the stage to a new position; these steps will be repeated until the stage has reached a position where the captured image of a component on the stage 5 has a level of focus which is above the threshold focus level.

As mentioned the stage 5 is configured such that it can be moved automatically or manually, to new positions; the stage 5 is moved iteratively to these new positions (and at each position the camera captures a new image of the component on the stage 5 which undergoes image processing at the processor 8 to determine the level of focus of the image). In the preferred embodiment the stage 5 is configured to move in steps of 50-100 μm i.e. the stage will move in iterations of between 50-100 μm. In another embodiment the size of the steps which the stage moves are adjusted according to the level of focus of the image which is determined by the processor. For example when the level of focus of the captured image is far from the threshold focus level then the stage moves in large steps (e.g. between 50-100 μm) and once the stage reaches a position when the level of focus of the captured image is close to the threshold focus level then the stage is moved in smaller steps (e.g. between 20-49 μm); the smaller step movements of the stage allow for finer adjustment of the position of the stage and thus finer adjustment of the level of focus.

The assembly 1 further comprises a memory 50 which can store the position of the stage. For example the memory can store the position of the stage 5 once the stage has reached a position where the captured image of a component on the stage 5 has a level of focus which is above the threshold focus level. The position(s) of the stage 5 stored in the memory is/are represented by coordinates, in particular values representing the location of the stage 5 along the two linear axes 9a, 9b. Most preferably the coordinates representing the position(s) of the stage also include an angle representing the rotation of the stage about the rotation axis 7 relative to a reference. In this example the memory 50 is provided in the second processor 18; however it should be understood that it is not essential for the memory 50 is provided in the second processor 18.

In this example, the assembly 1 further comprises a rotatable turret 51 which comprises a plurality of component handling heads 52. Each component handling head 52 can hold a respective component 10 by vacuum. Each component handling head 52 can deliver the component 10 it holds to the stage 5, and to pick the component 10 from the stage 5 after images of the component 10 have been captured. The turret rotates iteratively so that each component handling head 52 can deliver and pick their respective components 10 form the stage 5 consecutively. The assembly further comprises an alignment means 53 which can align the component 10 held on a respective component handling head 52 into a predefined position prior to the component handling head 52 reaching the stage 5.

The assembly 1 can be used to perform a method according to a further aspect of the present invention:

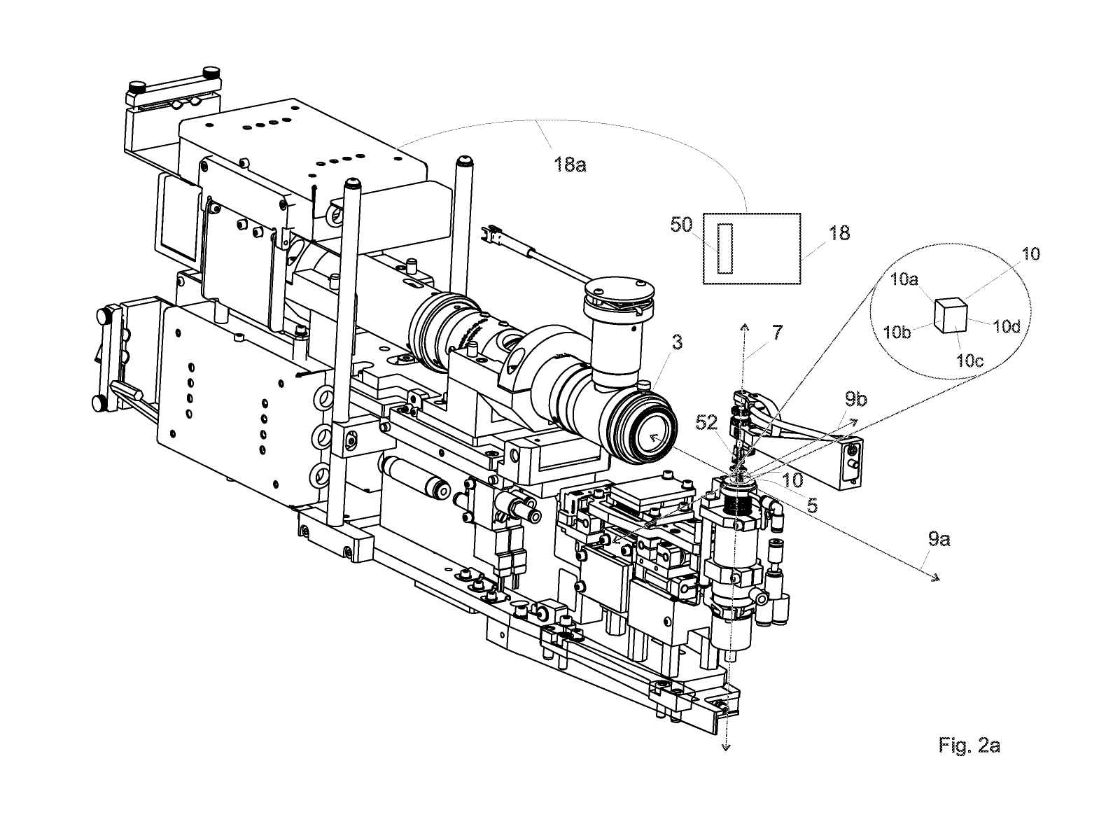

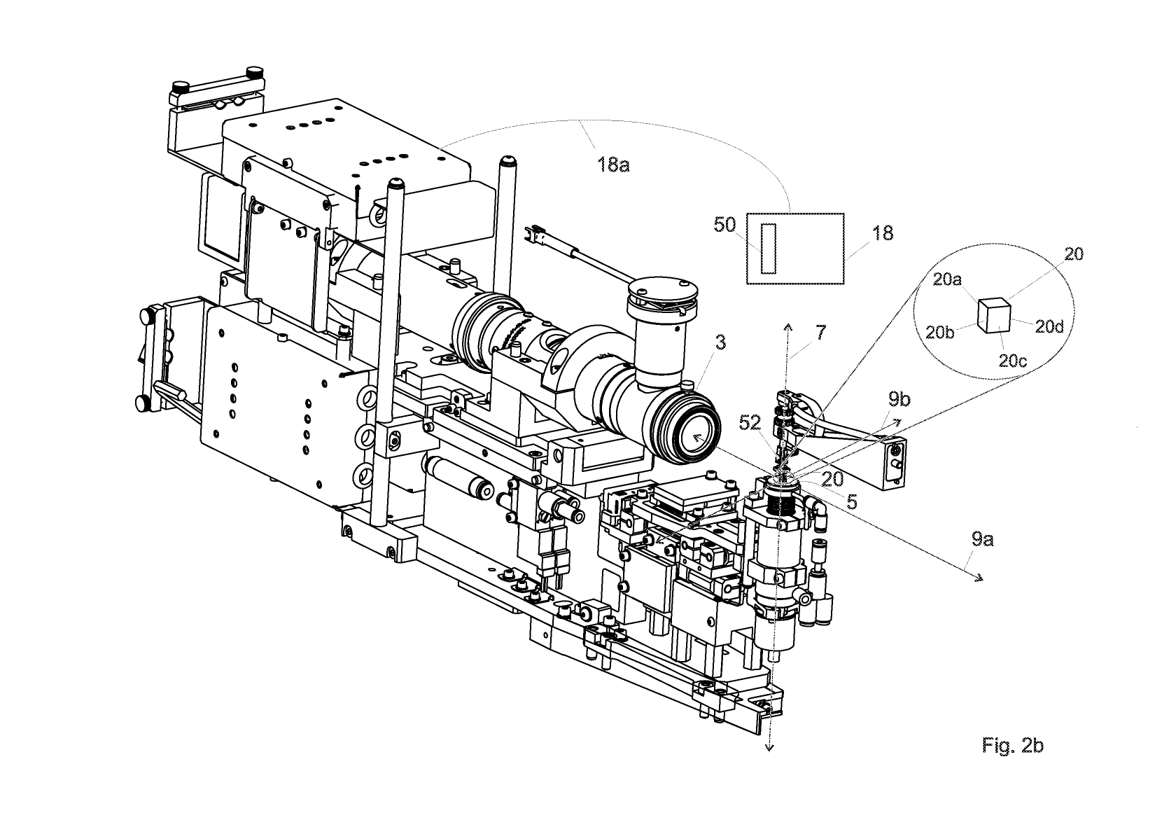

FIG. 2a shows the assembly in use to inspect a first component 10 (for clarity only a single component handling head 52 is illustrated and the turret 51 is not shown in full). The first component 10 to be inspected is provided into a predefined orientation on the stage 5. In this example said predefined orientation on the stage 5, is an orientation in which a first side 10a of the component 10 is facing a camera 3, and the first component 10 is positioned on the centre of the stage 5 such that the centre of the first component 10 overlays the centre of the stage 5. However it will be understood that the predefine orientation may be different depending on the shape and/or dimension of the component, and on the areas of the component which are to be inspected.

In this example the first component is a cube-shaped; thus the each side of the component will have equal dimensions. In this example four sides 10a-d of the component are to be inspected for cracks and/or contaminants.

Preferably the first component 10 will be delivered to the stage 5, to occupy said predefined orientation, by a component handling head on the rotatable turret 51. The component 10 will be held by vacuum on the component handling head 52 of the turret 51, and prior to reaching the stage 5 the component will be aligned (by an alignment means 53) into a predefined position on the component handling head, so that when the component handling head delivers the component to the stage 5 the first component 10 will be provided in said predefined orientation on the stage 5. Preferably the first component 10 is provided on the stage such that the centre of the first component 10 overlays the centre of the stage 5.

The stage 5 will preferably be initially located at a start position; at this start position the stage 5 will be aligned under the component handling head on the turret so that the component handling head of the turret can extend to deliver the first component 10 which it holds to the stage 5. After the first component 10 has be positioned onto the stage 5 the stage 5 is then moved linearly along one or more of said two linear axes 9a, 9b, and/or rotated about the rotation axis 7, so as to bring the first side 10a of the first component 10 into focus of the camera. In other words the stage 5 is moved linearly away or towards the camera 3, and/or to the left or right of the camera 3, and/or rotated about the rotation axis 7, so as to bring the first side 10a of the first component 10 to a position where it lies on the focal point of the camera 3. As already described above this may be done by moving the stage 5 iteratively to new positions and at each new position capturing an image of the first side 10a of the first component 10, until the stage 5 has reached a position where the camera captures an image of the first side 10a of the first component 10 which is determined by the processor 8 to have a level of focus which is above a threshold focus level. When the captured image of the first side 10a of the first component 10 is determined by the processor 8 to have a level of focus which is above a threshold focus level, then the first side 10a of the first component 10 will have been bought into focus of the camera. As mentioned above the movement of the stage 5 may be done manually, or automatically.

After the stage has been moved to bring the first side 10a of the first component 10 in to focus of the camera 3, an image of the first side 10a of the first component 10 is then captured using the camera 3.

The image of the first side 10a is inspected to identify if there are any cracks or contaminants present in the first side 10a of the first component 10.

After the stage 5 has been moved to bring the first side 10a of the first component 10 in to focus of the camera 3, position data (i.e. coordinates) indicative of the position of the stage 5 along said two linear axes 9a,9b and preferably also its rotation about the rotated about the rotation axis 7 relative to a reference, is then stored in the memory 50.

Next the stage 5 is rotated about the rotation axis 7 so that a second side 10b of the first component 10 is facing the camera 3. In this example since the component 10 is cube-shaped the stage 5 is rotated 90° about the rotation axis 7 so that the second side 10b of the first component 10 is facing the camera 3. The position of the stage 5 along the two linear axis 9a,9b is maintained in the same position along the two linear axis 9a,9b as when the image of the first side 10a of the first component 10 was captured; in other words during this step the stage 5 is only rotated about the rotation axis 7 to present the second side 10b of the first component 10 to the camera 3; no movement along either of the two linear axis 9a,9b takes place.

In the present example, because the first component 10 occupies said predefined position wherein the centre of the first component 10 overlays the centre of the stage 5, and because the first component 10 is cube-shaped with each side of the first component 10 having equal dimensions, when the stage 5 is rotated 90° about the rotation axis 7 so that the second side 10b of the first component 10 is facing the camera 3, the second side 10b of the first component 10 will be immediately in focus of the camera 3 without requiring adjustment of the position of the stage 5 along either of the two linear axis 9a,9b.

An image of the second side 10b of the component 10 is then captured using the camera 3. The image of the second side 10b is inspected to identify if there are any cracks or contaminants present in the second side 10b of the first component 10.

Next the stage 5 is rotated again about the rotation axis 7 so that a third side 10c of the component 10 is facing the camera 3. In this example since the component 10 is cube-shaped the stage 5 is rotated 90° about the rotation axis 7 so that the third side 10c of the component 10 is facing the camera 3. The position of the stage 5 along the two linear axis 9a,9b is maintained in the same position along the two linear axis 9a,9b as when the image of the first side 10a of the first component 10 was captured; in other words during this step the stage 5 is only rotated about the rotation axis 7 to present the third side 10c of the first component 10 to the camera 3; no movement along either of the two linear axis 9a,9b takes place.

The third side 10c of the first component 10 will be immediately in focus of the camera 3 without requiring adjustment of the position of the stage 5 along either of the two linear axis 9a,9b.

An image of the third side 10c of the component 10 is then captured using the camera 3. The image of the third side 10c is inspected to identify if there are any cracks or contaminants present in the third side 10c of the component 10.

Next the stage 5 is rotated again about the rotation axis 7 so that a fourth side 10d of the component 10 is facing the camera 3. In this example since the component 10 is cube-shaped the stage 5 is rotated 90° about the rotation axis 7 so that the fourth side 10d of the component 10 is facing the camera 3. The position of the stage 5 along the two linear axis 9a,9b is maintained in the same position along the two linear axis 9a,9b as when the image of the first side 10a of the first component 10 was captured; in other words during this step the stage 5 is only rotated about the rotation axis 7 to present the fourth side 10d of the first component 10 to the camera 3; no movement along either of the two linear axis 9a,9b takes place.

An image of the fourth side 10d of the component 10 is then captured using the camera 3. The image is inspected to identify if there are any cracks or contaminants present in the fourth side 10d of the component 10.

In the preferred embodiment, after the image of the fourth side 10d of the first component 10 has been captured the stage 5 is rotated again about the rotation axis 7 by 90° so as to bring the component back to it original orientation wherein the first side 10a of the first component 10 is facing the camera 3.

In this example , because the first component 10 occupies said predefined position wherein the centre of the first component 10 overlays the centre of the stage 5, and because the first component 10 is cube-shaped with each side of the first component 10 having equal dimensions, the second, third and fourth sides 10b-d of the first component 10 will be immediately in focus after rotating the stage 5 by respective 90°, without requiring adjustment of the position of the stage 5 along said two linear axes 9a,9b. Thus in this example, the stage 5 is moved along one or more of the two linear axis 9a,9b only to bring the first side 10a of the component 10 into focus of the camera, thereafter it is maintained in that position along the two linear axis 9a,9b for inspection of the remaining second, third and fourth sides 10b-d of the first component 10.

After images of the four sides 10a-d of the first component 10 have been captured (and optionally after said images have been inspected to identify if there are any cracks or contaminants in the first component 10) the first component 10 is then removed from the stage 5. In the preferred embodiment, after the image of the fourth side 10d of the first component 10 has been captured the stage 5 is rotated again about the rotation axis 7 by 90° before the component is removed from the stage 5. Typically the first component 10 will be removed from the stage 3 by a component handling head on the rotatable turret; a component handling head on a turret will extend and hold the first component 10 by vacuum before retracting to lift the first component from the stage 5. In some embodiment the stage 5 may be moved along one or both of the linear axes 9a, 9b, and/or rotated about the rotation axis 7, so as to bring the stage 5 back to its original start position; at the original start position the stage 5 (and the first component 10 on the stage) will be aligned beneath the component handling head on the turret 51 so that the component handling head can pick the component from the stage.

Typically after the first component 10 is removed from the stage 5 the first component 10 is sorted according to the results of the inspection; if the images showed that a side 10a-d of the first component had a crack or was contaminated, then the first component 10 is dumped in a bin; if the image showed that the sides 10a-d of the first component 10 were clear of any cracks and contamination, then the first component 10 is categorized as a ‘good’ component. Typically, the turret will then rotate to bring the ‘good’ component to a next processing station. The rotation of the turret will also bring the next component handling head on the turret, which holds another, second, component, to a position over the stage 5 where that component handling head can deliver the second component to the stage 5 for inspection.

Thus, in an embodiment of the present invention a second component 20 to be inspected, which has the same shape and dimensions as the first component 10, is provided in said predefined orientation on the stage 5, as is illustrated in FIG. 2b. As for the first component 10, the second component 20 will typically have been pre-aligned into a predefined position on the component handling head of a turret, so that when the component handling head delivers the second component 20 to the stage 5, the second component 20 will occupy said same predefined orientation as the first component 10. Preferably the second component 20 is provided on the stage such that the centre of the second component 20 overlays the centre of the stage 5.

Since the second component 20 to be inspected, has the same shape and dimensions as the first component 10, and since it too is placed in said predefined orientation on the stage 5, the first side 20a of the second component will be in focus of the camera 3 by moving the stage 5 to the same position as the position which the stage 5 occupied when the first side 10a of the first component 10 was in the focus of the camera 3. Accordingly, after the second component 20 has been positioned onto the stage 5, the position data (i.e. coordinates) which were stored in the memory 50 which represent the position of the stage 5 when the first side 10a of the first component 10 was in focus of the camera 3 (i.e. the position data indicative of the position of the stage 5 along said two linear axes 9a,9b and its rotation about the rotation axis 7 relative to a reference) is then retrieved. The stage 5 is then moved (automatically or manually) from its starting position (where the second component 20 was delivered to the stage5) to a position corresponding to position represented by the retrieved position data. Moving the stage to a position corresponding to position represented by the retrieved position data will bring the first side 20a of the second component 20 into the focus of the camera 3 without requiring adjustment of the camera and without requiring further adjustment of the position of the stage along the two linear axis 9a,9b or about the rotation axis 7. Accordingly an image of the first side 20a of the second component 20 can be captured by the camera 3 immediately after the stage has been moved to a position corresponding to position represented by the retrieved position data.

The stage 5 is then rotated consecutively by 90°, and images of the second, third and fourth sides 20a-d of the second component 20 are captured in the same manner as described above for the first component 10.

A plurality of components, each having the same shape and dimensions as the first component 10, can be consecutively inspected in the same manner as the second component 20, without requiring adjustment of the camera or adjustment of the position of the stage along the two linear axis 9a,9b.

In another embodiment of the present invention a first component 100 having a rectangular-cuboid-shape is to be inspected. FIG. 2 shows a perspective view of the assembly 1 in use to inspect a first component 100 having a rectangular-cuboid-shape. The first component 100 has a first, second, third and fourth side 100a-d which are to be inspected. The first and third sides 100a,c each have a length (measured along the plane of the component 100) which is longer than the length second and fourth sides 100b,d of the first component 100.

The first component 100 is provided into a predefined orientation on the stage 5. Preferably the first component 100 is positioned on the stage such that the centre of the first component 100 overlays the centre of the stage 5. However it will be understood that the predefine orientation may be different depending on the shape and/or dimension of the component, and on the areas of the component which are to be inspected. However, it should be understood that components which are consecutively provided on the stage 5 for inspection will each be positioned in the same predefined orientation on the stage.

Typically the first component 100 will be delivered to the stage 3 by a component handling head on the rotatable turret; the first component 100 will be held by vacuum on the component handling head of the turret, and prior to reaching the stage 5 the first component 100 will be aligned (by an alignment means) into a predefined orientation on the component handling head, so that when the component handling head delivers the component to the stage 5 the first component 100 will be provided in said predefined orientation on the stage 5.

The stage 5 will preferably be initially located at a start position; at this start position the stage 5 will be aligned under the component handling head on the turret so that the component handling head of the turret can extend to deliver the first component 10 which it holds to the stage 5. After the first component 100 has be positioned onto the stage 5, the stage 5 is then moved linearly along one or more of said two linear axes 9a, 9b, and/or rotated about the rotation axis 7, so as to bring the first side 100a of the first component 100 into focus of the camera 3. In other words the stage 5 is moved linearly away or towards the camera 3, and/or to the left or right of the camera 3, and/or rotated about the rotation axis 7, so as to bring the first side 100a of the first component 100 in to focus of the camera 3. In this example the stage 5 is moved linearly away or towards the camera 3, and/or to the left or right of the camera 3, and/or rotated about the rotation axis 7, so as to bring the first side 100a of the first component 100 to a position where the camera 3 can capture an image of the first side 100a of the first component 100 which has a level of focus (as determined by the processor 8) which is above the threshold focus level. Most preferably the stage 5 is moved so as to bring the first side 100a of the first component 100 to a position where the first side 100a lies on the focal point of the camera 3.

As already described above, moving the stage 5 so as to bring the first side 100a of the first component 100 in to focus of the camera 3 can be done by moving the stage 5 iteratively to new positions and at each new position capturing an image of the first side 100a of the first component 100, until the stage 5 has reached a position where the camera captures an image of the first side 100a of the first component 100 which is determined by the processor 8 to have a level of focus which is above a threshold focus level. When the captured image of the first side 100a of the first component 100 is determined by the processor 8 to have a level of focus which is above a threshold focus level, then the first side 100a of the first component 100 will have been bought into focus of the camera. As mentioned above the movement of the stage 5 may be done manually, or automatically.

After the stage 5 has been moved to bring the first side 100a of the first component 100 in to focus of the camera 3, an image of the first side 100a of the first component 100 is then captured using the camera 3. The image is inspected to identify if there are any cracks or contaminants present in the first side 100a of the first component 100.

Importantly, in this embodiment, after the stage 5 has been moved to bring the first side 100a of the first component 100 in to focus of the camera 3, first position data (i.e. coordinates) indicative of the position of the stage 5 along said two linear axes 9a,9b and preferably also its rotation about the rotated about the rotation axis 7 relative to a reference, are then stored in the memory 50. In the most preferred embodiment the first position data is stored in the memory 50 in association with an identity which identifies the type of component which was inspected; this will enable the first position data to be retrieved from the memory 50 based on the type of the component which is to be inspected.

Next the stage 5 is rotated about the rotation axis 7 so that a second side 100b of the first component 100 is facing the camera 3. In this example since the first component 100 is rectangular-cuboid-shaped the stage 5 is rotated 90° about the rotation axis 7 so that the second side 100b of the first component 100 is facing the camera 3.

However since the first 100a has a length which is longer than second side 100b of the first component 100, and since the first component 100 is positioned on the stage such that the centre of the first component 100 overlays the centre of the stage 5, when the stage 5 is rotated 90° so that a second side 100b of the first component 100 is facing the camera 3, the second side 100b will be closer to the camera 3 than the first side 100a was; accordingly the second side 100b will not be in focus of the camera 3. Therefore in this embodiment, after the stage 5 has been rotated about the rotation axis 7 so that a second side 100b of the first component 100 is facing the camera 3, the stage 5 is then moved linearly along one or more of said two linear axes 9a, 9b so as to bring the second side 100b of the first component 100 into focus of the camera. It should be understood that the stage 5 can be moved linearly along one or more of said two linear axes 9a, 9b so as to bring the second side 100b of the first component 100 into focus of the camera, simultaneous to rotating the stage 5 by 90° about the rotation axis 7. In other words the stage 5 is moved linearly away or towards the camera 3, and/or to the left or right of the camera 3, so as to bring the second side 100b of the first component 100 to a position where it lies on the focal point of the camera 3. As already described above this may be done by moving the stage 5 iteratively to new positions and at each new position capturing an image of the second side 100b of the first component 100, until the stage 5 has reached a position where the camera captures an image of the second side 100b of the first component 100 which is determined by the processor 8 to have a level of focus which is above a threshold focus level. When the captured image of the second side 100a of the first component 100 is determined by the processor 8 to have a level of focus which is above a threshold focus level, then the second side 100a of the first component 100 will have been bought into focus of the camera 3. As mentioned above the movement of the stage 5 may be done manually, or automatically.

After the stage has been moved to bring the second side 100b of the first component 100 in focus of the camera 3, an image of the second side 100b of the first component 100 is then captured using the camera 3. The image is inspected to identify if there are any cracks or contaminants present in the second side 100b of the first component 100.

Importantly, in this embodiment, after the stage 5 has been moved to bring the second side 100b of the first component 100 in to focus of the camera 3, second position data (i.e. coordinates) indicative of the position of the stage 5 along said two linear axes 9a,9b and preferably also its rotation about the rotated about the rotation axis 7 relative to a reference, are then stored in the memory 50. In the most preferred embodiment the second position data is stored in the memory 50 in association with an identity which identifies the type of component which was inspected; this will enable the second position data to be retrieved from the memory 50 based on the type of the component which is to be inspected.

Next the stage 5 is rotated about the rotation axis 7 so that a third side 100c of the first component 100 is facing the camera 3. In this example since the first component 100 is rectangular-cuboid-shaped the stage 5 is rotated 90° about the rotation axis 7 so that the third side 100c of the first component 100 is facing the camera 3.

Since the first component 100 is rectangular-cuboid-shaped and is centred on the stage 5, the third side 100c of the first component can be brought into the focus of the camera 3, by moving the stage 5 to the same position as the position which the stage 5 occupied when the first side 100a of the first component 100 was in the focus of the camera 3. Accordingly, after the stage 5 is rotated about the rotation axis 7 so that a third side 100c of the first component 100 is facing the camera 3, the first position data (i.e. coordinates) which were stored in the memory 50, which represent the position of the stage 5 when the first side 100a of the first component 100 was in focus of the camera 3, is then retrieved from the memory 50. The stage 5 is then moved (automatically or manually) to a position corresponding to position represented by the retrieved first position data. Moving the stage 5 to a position corresponding to position represented by the retrieved first position data will bring the third side 100c of the first component 100 into the focus of the camera 3 without requiring adjustment of the camera and without requiring further adjustment of the position of the stage 5 along the two linear axis 9a,9b or about the rotation axis 7. Accordingly an image of the third side 100c of the first component 100 can be captured by the camera 3 immediately after the stage has been moved to a position corresponding to position represented by the retrieved first position data.

After the stage has been moved to a position corresponding to position represented by the retrieved first position data, an image of the third side 100c of the first component 100 is captured by the camera 3. The image is inspected to identify if there are any cracks or contaminants present in the third side 100c of the component 100.

Next the stage 5 is rotated about the rotation axis 7 so that a fourth side 100d of the first component 100 is facing the camera 3. In this example since the first component 100 is rectangular-cuboid-shaped the stage 5 is rotated 90° about the rotation axis 7 so that the fourth side 100d of the first component 100 is facing the camera 3.

Since the first component 100 is rectangular-cuboid-shaped and is centred on the stage 5, the fourth side 100d of the first component 100 can be brought into the focus of the camera 3, by moving the stage 5 to the same position as the position which the stage 5 occupied when the second side 100b of the first component 100 was in the focus of the camera 3. Accordingly, after the stage 5 is rotated about the rotation axis 7 so that a fourth side 100d of the first component 100 is facing the camera 3, the second position data (i.e. coordinates) which were stored in the memory 50, which represent the position of the stage 5 when the second side 100b of the first component 100 was in focus of the camera 3 is then retrieved from the memory 50. The stage 5 is then moved (automatically or manually) to a position corresponding to the position represented by the retrieved second position data. Moving the stage 5 to a position corresponding to position represented by the retrieved second position data will bring the fourth side 100d of the first component 100 into the focus of the camera 3 without requiring adjustment of the camera and without requiring further adjustment of the position of the stage 5 along the two linear axis 9a,9b or about the rotation axis 7. Accordingly an image of the fourth side 100d of the first component 100 can be captured by the camera 3 immediately after the stage has been moved to a position corresponding to position represented by the retrieved second position data.

After the stage has been moved to a position corresponding to position represented by the retrieved second position data, an image of the fourth side 100d of the first component 100 is captured by the camera 3. The image is inspected to identify if there are any cracks or contaminants present in the fourth side 100c of the component 100.

In the above embodiment each of the respective images are inspected prior to capturing the next image of the next side 100a-d of the first component 100; however in a variation of this embodiment, each of the four images of the four sides 100a-d of the first component 100 are first captured, and four images are inspected to identify if there are any cracks or contaminants present in any of the sides only after the four images have been captured.

After images of the four sides 100a-d of the component 100 have been captured (and optionally after said images have been inspected to identify if there are any cracks or contaminants in the first component 100) the first component 100 is then removed from the stage 5. In the preferred embodiment, after the image of the fourth side 100d of the first component 100 has been captured the stage 5 is rotated again about the rotation axis 7 by 90° so as to bring the component back to its original orientation wherein the first side 100a of the first component 100 is facing the camera 3, before removing the first component from the stage 5.

Typically the first component 100 will be removed from the stage 5 by a component handling head on the rotatable turret; a component handling head on a turret will extend and hold the first component 100 by vacuum, before retracting to lift the first component 100 from the stage 5. In an embodiment the stage 5 may be moved along one or both of the linear axes 9a, 9b, and/or rotated about the rotation axis 7, so as to bring the stage 5 back to its original start position; at the original start position the stage 5 (and the first component 100 on the stage) will be aligned beneath a component handling head on the turret 51 so that the component handling head can pick the component from the stage 5.

Typically after the first component 100 is removed from the stage 5 the first component 100 is sorted according to the results of the inspection; if the images showed that a side 100a-d of the first component 100 had a crack or was contaminated, then the first component 100 is dumped in a bin; if the images showed that the sides 100a-d of the first component 100 were clear of any cracks and contamination, then the first component 100 is categorized as a ‘good’ component. Typically, the turret will rotate to bring the ‘good’ component to a next processing station. The rotation of the turret will also bring the next component handling head on the turret, which holds another, second, component, to a position over the stage 5 where that component handling head can deliver that second component to the stage 5 for inspection.

Thus, in one an embodiment a second component 200 to be inspected, which has the same shape and dimensions as the first component 100, is provided in said predefined orientation on the stage 5. The second component 200 is positioned on the centre of the stage 5 such that the centre of the second component 200 overlays the centre of the stage 5. As for the first component 100, the second component 200 will typically have been pre-aligned into a predefined position on the component handling head of a turret, so that when the component handling head delivers the second component 200 to the stage 5, the second component 200 will occupy the predefined orientation.

Since the second component 200 to be inspected, has the same shape and dimensions as the first component 100, and since it too is placed in said predefined orientation on the stage 5, the same positions of the stage 5 along the two linear axes 9a,9b required to bring the respective first, second, third and fourth sides 100a-d of the first component 100 into the focus of the camera 3, will also bring the respective first, second, third and fourth sides 200a-d of the second component 200 into the focus of the camera 3.

Accordingly, after the second component 200 is provided in said predefined orientation on the stage 5, the first position data (i.e. coordinates) which were stored in the memory 50, which represent the position of the stage 5 when the first side 100a of the first component 100 was in focus of the camera 3, is then retrieved from the memory 50. The stage 5 is then moved (automatically or manually) to a position corresponding to position represented by the retrieved first position data. Moving the stage 5 to a position corresponding to position represented by the retrieved first position data will bring the first side 200a of the second component 200 into the focus of the camera 3 without requiring adjustment of the camera and without requiring further adjustment of the position of the stage 5 along the two linear axis 9a,9b or about the rotation axis 7. Accordingly an image of the first side 200a of the second component 200 can be captured by the camera 3 immediately after the stage has been moved to a position corresponding to position represented by the retrieved first position data. It should be understood that in some embodiments this step of moving the stage to the same position along said two linear axes 9a,9b as the position indicated in the said retrieved first position data may not be necessary since the stage 5 may already occupy a position corresponding to the position indicated in the first position data.

After the stage 5 has been moved to a position corresponding to position represented by the retrieved first position data, an image of the first side 100a of the second component 200 is captured by the camera 3. The image is then inspected to identify if there are any cracks or contaminants present in the first side 200a of the second component 200.

Next the stage 5 is rotated about the rotation axis 7 so that the second side 200b of the second component 200 is facing the camera 3. In this example since the second component 200 is rectangular-cuboid-shaped so the stage 5 is rotated 90° about the rotation axis 7 so that the second side 200b of the second component 200 is facing the camera 3.

The second side 200d of the second component 200 will be brought into the focus of the camera 3, by moving the stage 5 to the same position as the position which the stage 5 occupied when the second side 100b of the first component 100 was in the focus of the camera 3. Accordingly, after the stage 5 is rotated about the rotation axis 7 so that a second side 200b of the second component 200 is facing the camera 3, the second position data (i.e. coordinates) which were stored in the memory 50, which represent the position of the stage 5 when the second side 100b of the first component 100 was in focus of the camera 3, is then retrieved from the memory 50. The stage 5 is then moved (automatically or manually) to a position corresponding to the position represented by the retrieved second position data. Moving the stage 5 to a position corresponding to position represented by the retrieved second position data will bring the second side 200d of the second component 200 into the focus of the camera 3 without requiring adjustment of the camera and without requiring further adjustment of the position of the stage 5 along the two linear axis 9a,9b or about the rotation axis 7. Accordingly an image of the second side 200d of the second component 200 can be captured by the camera 3 immediately after the stage has been moved to a position corresponding to position represented by the retrieved second position data.

After the stage 5 has been moved to a position corresponding to position represented by the retrieved second position data, an image of the second side 200b of the second component 200 is captured by the camera 3. The image is then inspected to identify if there are any cracks or contaminants present in the second side 200b of the second component 200.

Next the stage 5 is rotated about the rotation axis 7 so that the third side 200c of the second component 200 is facing the camera 3. In this example since the second component 200 is rectangular-cuboid-shaped so the stage 5 is rotated 90° about the rotation axis 7 so that the third side 200c of the second component 100 is facing the camera 3.

Then the first position data, indicative of the position of the stage 5 along said two linear axes 9a,9b when the first side 100a of the first component 100 was in focus of the camera 3, is then retrieved from the memory. The stage 5 is then moved to the same position along said two linear axes 9a,9b as the position indicated in the said retrieved first position data.

When the stage has been moved to the same position along said two linear axes 9a,9b as the position indicated in the said retrieved first position data, the third side 200c of the second component 200 will be in focus of the camera 3. An image of the third side 200c of the second component 200 is then captured by the camera 3. The image is then inspected to identify if there are any cracks or contaminants present in the third side 200c of the second component 200.

Next the stage 5 is rotated about the rotation axis 7 so that the fourth side 200d of the second component 200 is facing the camera 3. In this example since the second component 200 is rectangular-cuboid-shaped so the stage 5 is rotated 90° about the rotation axis 7 so that the fourth side 200d of the second component 200 is facing the camera 3.

Then the second position data, indicative of the position of the stage 5 along said two linear axes 9a,9b when the second side 100b of the first component 100 was in focus of the camera 3, is then retrieved from the memory. The stage 5 is then moved to the same position along said two linear axes 9a,9b as the position indicated in the said retrieved second position data.

When the stage has been moved to the same position along said two linear axes 9a,9b as the position indicated in the said retrieved second position data, the fourth side 200d of the second component 200 will be in focus of the camera 3. An image of the fourth side 200d of the second component 200 is then captured by the camera 3. The image is then inspected to identify if there are any cracks or contaminants present in the fourth side 200d of the second component 200.

After images of the four sides 200a-d of the second component 200 have been captured (and optionally after the images have been inspected to identify if there are any cracks or contaminants in the second component 200) the second component 200 is then removed from the stage 5.

Typically the second component 200 will be removed from the stage 3 by a component handling head on the rotatable turret; a component handling head on a turret will extend and hold the second component 200 by vacuum before retracting to lift the second component 200 from the stage 5.

Typically after the second component 200 has been removed from the stage 5 the second component 200 is sorted according to the results of the inspection; if the images showed that a side 200a-d of the second component 200 had a crack or was contaminated, then the second component 200 is dumped in a bin; if the image showed that the sides 200a-d of the second component 200 were clear of any cracks and contamination, then the second component 200 is categorized as a ‘good’ component. Typically, the turret will then rotate to bring the ‘good’ component to a next processing station. The rotation of the turret will also bring the next component handling head on the turret, which holds another, third, component, to a position over the stage 5 where that component handling head can deliver the third component to the stage 5 for inspection.

The above-mentioned steps described for the inspecting the second component 200 can be carried out to inspect, consecutively, a plurality of components each of which have the same dimensions as the second component 200. Thus a plurality of component can be inspected without having to refocus camera for each component, and without having to determine positions for each of the plurality of components required to bring a side of that component into focus of the camera; accordingly the plurality of components can be inspected quickly and reliably.

It should be understood in the above-mentioned embodiment since the position data is stored in the memory 50 in association with an identity which identifies the type of component which was inspected; this will enable the position data to be retrieved from the memory 51 based on the type of the component which is to be inspected. For example the assembly may be used to inspect a number of different types of components, using the identification of each component the corresponding position data for the stage for each component may be retrieved from the memory. So the memory 51 may store position data for stage for different types of components; and the appropriate position data may be retrieved from memory according to the type of component to be inspected using the identification.

In a further embodiment the assembly is configured to perform an auto check the focus position. In other words the assembly 1 detects automatically if the component to be inspected requires a different stage position in order to bring the respective sides of that component into the focus of the camera 3.

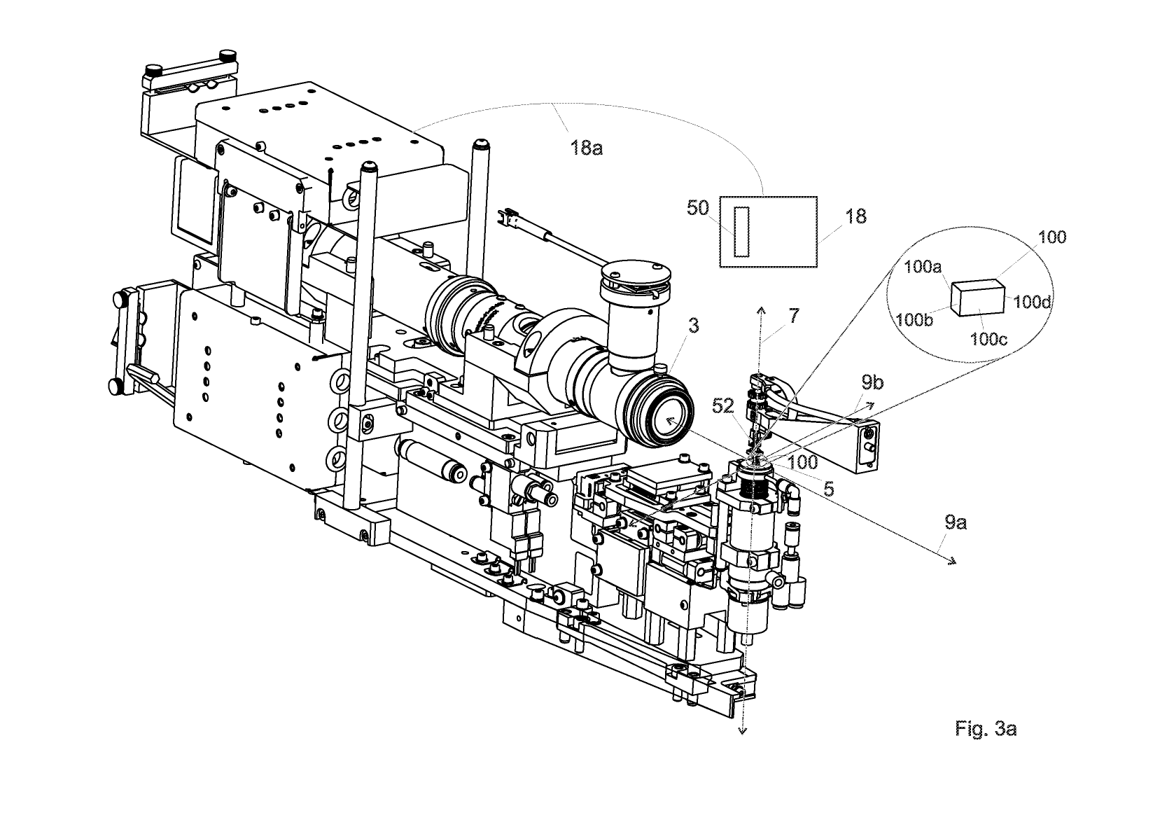

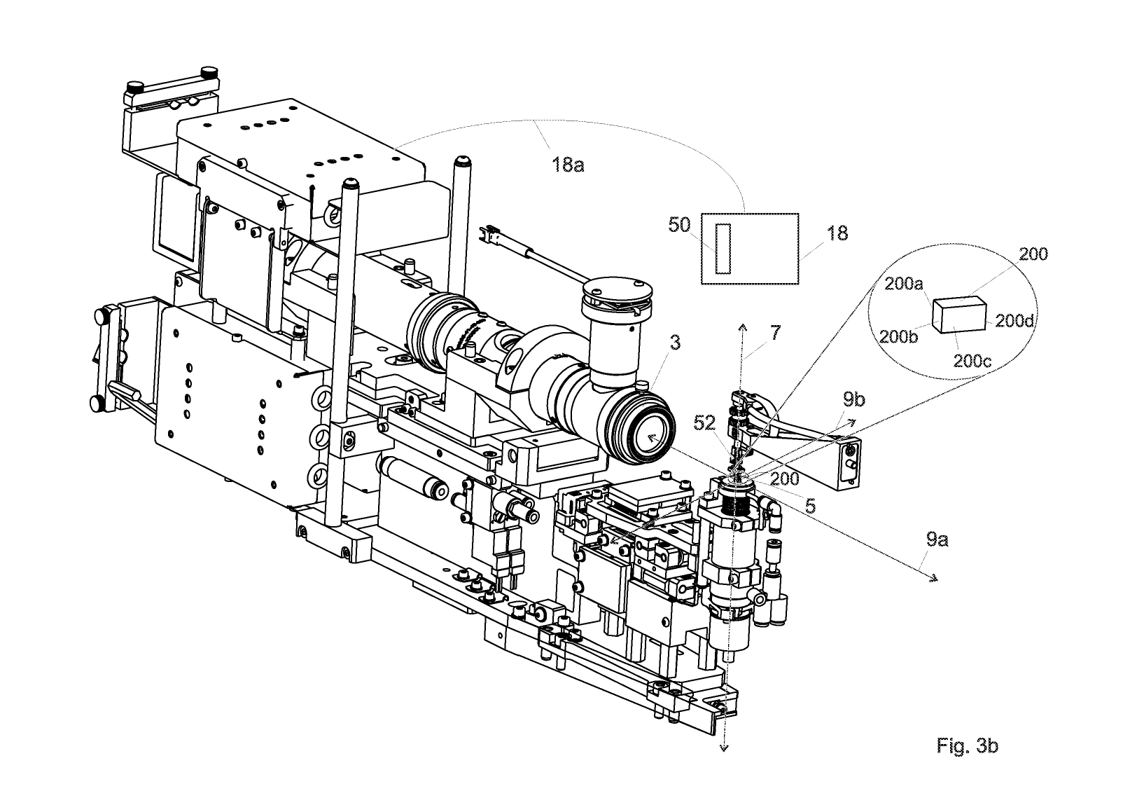

In a further embodiment of the present invention, a third component 300 to be inspected, which has different dimensions to the first and second components 100, 200, is provided on the stage 5. FIG. 3 shows a perspective view of the assembly 1 in use to inspect a third component 300 which has different dimensions to the first and second components 100, 200, is provided on the stage 5.

In this example the third component 300 is also rectangular-cuboid-shaped having four sides 300a-d which are to be inspected; thus the third component 300 has the same shape as the first and second components 100,200 but the dimensions of the third component 300 are different to the first and second components 100,200. In this example the third component 300 has larger dimensions than the first and second components 100,200 i.e. the third component 300 is longer, wider and has a larger height than the length, width and height of the first and second components 100,200. However it will be understood that the third component may have any shape or dimension which is different to the shape or dimension of the first and second components 100,200.

The third component 300 is provided in a predefined orientation on the stage 5. Preferably the third component 300 is positioned on the centre of the stage 5 such that the centre of the third component 300 overlays the centre of the stage 5. It should be understood that the predefine orientation may depend on the shape and/or dimension of the component, and on the areas of the component which are to be inspected.

After the third component 300 is provided in said predefined orientation on the stage 5, then first position data, indicative of the position of the stage 5 along said two linear axes 9a,9b when the first side 100a of the first component 100 was in focus of the camera 3, is then retrieved from the memory. The stage 5 is then moved to the same position along said two linear axes 9a,9b as the position indicated in the said retrieved first position data.

An image of the first side 300a of the third component 300 is then captured by the camera 3. In a next step it is detected from the captured image that the first side 300a of the third component 300 is not in the focus of the camera 3. For example the processor 8 may determine that the captured image has a level of focus which is below the threshold level of focus.

Since the third component 300 has larger dimensions than the first and second component 100,200, when the stage 5 is moved to the same position along said two linear axes 9a,9b as the position indicated in the said retrieved first position data, the first side 300a of the third component 300 will be too close to the camera 3 to be in focus of the camera 3. Likewise, if the third component 300 has smaller dimensions than the first and second component 100,200, then the first side 300a of the third component will be too far from the camera to be in focus when the stage 5 is moved to the same position along said two linear axes 9a,9b as the position indicated in the said retrieved first position data. In other words, in both cases, the first side 300a of the third component will be in the focus of the camera 3 so as to allow the camera 3 to capture an image of the first side 300a which has a level of focus about the threshold level of focus.

After detecting from the captured image that the first side 300a of the third component 300 is not in the focus of the camera 3, the steps described above for the first component 100 are carried out for the third component 300 so as to capture (and inspect) images of each of the four sides 300a-d of the third component 300, and to store in the memory 50 third position data indicative of the position of the stage 5 along said two linear axes 9a,9b and rotation about the rotation axis 7, where the first side 300a of the third component 300 is in focus of the camera; and fourth position data indicative of the position of the stage 5 along said two linear axes 9a,9b and rotation about the rotation axis 7, where the second side 300b of the third component 300 is in focus of the camera 3.

The above-mentioned steps described for the inspecting the second component 200 can be carried out to inspect, consecutively, a plurality of components each of which have the same dimensions as the third component 300, using the third and fourth position data (instead of the first and second position data).

Thus in this embodiment, when a different shaped and/or different dimensioned component is provided on the stage 5 for inspection, it is automatically detected from an image of a component that recalibration of the positioning of the stage 5 along one or more of said two linear axes 9a,9b and possibly also rotation about the rotation axis 7, is required in order to bring the sides of the component in to focus of the camera 3. When it is detected that the image of a component is out of focus, the positioning of the stage 5 along one or more of the two linear axes 9a,9b is adjusted, and/or possibly also rotation about the rotation axis 7 is adjusted, to bring the sides of the component into focus, and the new positions for stage at which the sides of the component are in focus of the camera 3, are stored in the memory.

Various modifications and variations to the described embodiments of the invention will be apparent to those skilled in the art without departing from the scope of the invention as defined in the appended claims. Although the invention has been described in connection with specific preferred embodiments, it should be understood that the invention as claimed should not be unduly limited to such specific embodiment.

1. A method of inspecting a component, using an assembly comprising a camera with a fixed position, and a moveable stage, wherein the moveable stage is configured such that it can rotate about a rotation axis, and, can move linearly along two linear axes wherein said two linear axes are perpendicular to one another and wherein both of said two linear axes are each perpendicular to the rotation axis, the method comprising the steps of, providing a first component into a predefined orientation on the stage, such that a first side of the component is facing a camera;
moving the stage linearly along one or more of said two linear axes so as to bring the first side of the first component into focus of the camera;
capturing an image of the first side of the first component after it has been brought into focus of the camera.

2. A method according to claim 1 comprising the steps of, while maintaining the stage in the same position along the linear axes as when the image of the first side was captured, rotating the stage about said rotation axis so that a second side of the first component is facing the camera;
capturing an image of the second side of the first component after it has been brought into focus of the camera.

3. A method according to claim 1 comprising the steps of, while maintaining the stage in the same position along the linear axes as when the image of the first side was captured, removing the first component from the stage;
providing a second component, which has the same dimensions as the first component, into a predefined orientation on the stage, such that a first side of the second component is facing a camera;
capturing an image of the first side of the second component using the camera;
rotating the stage about said rotation axis so that a second side of the second component is facing the camera;
capturing an image of the second side of the second component using the camera.

4. A method according to any one of claims claim 1 wherein said first component is cube-shaped.

5. A method according to claim 1 comprising the steps of,
storing, in a memory, first position data indicative of the position of the stage along said two linear axes, when the first side of the first component is in focus of the camera;
rotating the stage about said rotation axis so that a second side of the first component is facing the camera;
moving the stage linearly along one or more of said two linear axes so as to bring the second side of the first component into focus of the camera;
storing, in a memory, second position data indicative of the position of the stage along said two linear axes, when the second side of the first component is in focus of the camera;
capturing an image of the second side of the first component after it has been brought into focus of the camera.

6. A method according to claim 5 comprising the steps of,
rotating the stage about said rotation axis so that a third side of the first component is facing the camera;
retrieving the first position data from the memory, and moving the stage to a position corresponding to the position indicated in the retrieved first position data, so as to bring the third side of the first component into focus;
capturing an image of the third side of the first component after it has been brought into focus of the camera;
rotating the stage about said rotation axis so that a fourth side of the first component is facing the camera;
retrieving the second position data from the memory, and moving the stage to a position corresponding to the position indicated in the retrieved second position data, so as to bring the fourth side of the first component into focus of the camera;
capturing an image of the fourth side of the first component after it has been brought into focus of the camera.

7. A method according to any one of claims claim 5, comprising the steps of, removing the first component from the stage;
providing a second component, which has the same dimensions as the first component, into a predefined orientation on the stage, such that a first side of the second component is facing a camera;
capturing an image of the first side of the second component using the camera;
rotating the stage about said rotation axis so that a second side of the second component is facing the camera;
retrieving the second position data from the memory, and moving the stage to a position corresponding to the position indicated in the retrieved second position data, so as to bring the second side of the second component into focus of the camera;
capturing an image of the second side of the second component using the camera.

8. A method according to claim 7 further comprising the step of retrieving the first position data from the memory, and moving the stage to a position corresponding to the position indicated in the retrieved first position data, so as to bring the first side of the second component into focus of the camera.

9. A method according to claim 5 wherein said first component is rectangular-cuboid-shaped.

10. A method according to claim 1 wherein the method further comprises the step of inspecting a captured image to identify if the side of the component has a crack or is contaminated.

11. A method according to claim 5 comprising the step of, removing the first component from the stage, providing a second component which has dimensions which are different to the dimensions of the first component, into said predefined orientation on the stage such that a first side of the second component is facing a camera;
retrieving first position data from memory, and moving the stage to a position corresponding to the position indicated in the retrieved first position data;
capturing an image of the first side of the second component using the camera;
detecting from the captured image that the second component is out of the focus of the camera;
moving the stage linearly along one or more of said two linear axes so as to bring the first side of the second component into focus of the camera;
capturing an image of the first side of the second component after it has been brought into focus of the camera;
storing, in a memory, third position data indicative of the position of the stage along said two linear axes, when the first side of the second component is in focus of the camera;
rotating the stage about said rotation axis so that a second side of the second component is facing the camera;
moving the stage linearly along one or more of said two linear axes so as to bring the second side of the second component into focus of the camera;
storing, in a memory, fourth position data indicative of the position of the stage along said two linear axes, when the second side of the second component is in focus of the camera;
capturing an image of the second side of the second component after it has been brought into focus of the camera.
An assembly for inspecting a component, the assembly comprising, a camera having a fixed position; and
a moveable stage, wherein the moveable stage is configured such that it can rotate about a rotation axis, and, can move linearly along two linear axes wherein said two linear axes are perpendicular to one another and wherein both of said two linear axes are each perpendicular to the rotation axis;
a processor which is configured to, receive an image captured by the camera and to determined if the image is in-focus and, if the image is not in-focus then determines a movement of the moveable stage required to bring the component into focus of the camera, and to initiate the moveable stage to undergo said determined movement so as to bring the component into focus of the camera.
